(19) United States
(12) Patent Application Publication
(10) Pub. No.: US 2008/0141234 A1
(43) Pub. Date: Jun. 12, 2008

(54) Method and system for executing and configuring applications on the basis of a use environment

(76) Inventors: Detlef BECKER, Mohrendorf (DE); Karlheinz DORN, Kalchreuth (DE); Hans-Martin VON STOCKHAUSEN, Erlangen (DE)

Correspondence Address: HARNESS, DICKEY & PIERCE, P.L.C., P.O.BOX 8910, RESTON, VA, 20195, US

(21) Appl. No.: 11/976,808

(22) Filed: Oct. 29, 2007

(30) Foreign Application Priority Data
Oct. 30, 2006 (DE) 10 2006 051 189.1

(51) Int. Cl. G06F 9/44

(52) U.S. Cl. 717/162

(57) ABSTRACT

Methods are disclosed for creating and executing at least one application on the basis of a use environment. For the creation, a method of an embodiment includes: a set of modules is provided in which at least one functionality for creating the application is respectively implemented, functionalities required for the respective application are selected, and the selected functionalities are configured for an application, where the modules are already in the form of compiled executable program code and at least particular modules are designed for different use environments, and where modules are automatically selected and the application is configured such that modules suited to differently identified use environments can be dynamically connected together at runtime without the need to recompile the application.

### PRIORITY STATEMENT

The present application hereby claims priority under 35 U.S.C. §119 on German patent application number DE 10 2006 051 189.1 filed Oct. 30, 2006, the entire contents of which is hereby incorporated herein by reference.

### FIELD

Embodiments of the invention are generally in the field of application and/or taskflow management, particularly in the area of medical engineering.

In particular, embodiments of the invention may generally relate to a method and/or a system for configuring and executing an application in a variable use environment and to an approach for programming such configurations.

### BACKGROUND

In the field of application development for medical imaging applications, today's prior art has provision for creating an application almost exclusively monolithically and hence for providing an application block which accordingly needs to be changed repeatedly when changes are required (new updates, new versions etc). This results in increased complexity for creating the application and for maintaining it. Furthermore, these systems with a monolithic basis are relatively susceptible to error. Application systems to date frequently have provision for an application to be “linked” together from individual libraries and to be executed within an executable.

If an application of this kind now needs to be changed or if it needs to be adapted to other use environments or to other deployments or to another underlying architecture then relatively extensive adaptation measures are normally required. In particular, it is necessary to create a new source code, which needs to be translated (compiled) again, in order to obtain an executable file (executable). This practice hitherto is disadvantageously relatively time consuming and work intensive.

Today's software technology is not sufficiently flexible to adapt itself to different use environments, such as particularly deployments, in particular without changes to programs and hence to the holding of a plurality of program versions. In this context, use environment is to be understood to mean the total number of all constraints which a particular program can find at the start and in the course of its execution. These are to be understood to mean particularly deployments, that is to say intended, predetermined strategies for the execution of program components on particular computers and the distribution of the individual components over the computers at runtime, but furthermore or alternatively also such variables as performance of the computer (e.g. operations per unit time), site, connection to a data-supplying network etc.

In the area of medical engineering, for example, the “Syngo®” system developed by Siemens comprises a series of individual applications which are able to handle and process medical data, such as image data from computer tomographs etc. However, these monolithic programs cannot adapt themselves to the desired use environment, and thus different variants of the programs need to be held. By way of example, various types of access therefore need to be implemented, such as stateful access operations, in the case of fixed network connections or local execution, while web access operations, depending on the HTTP protocol used, require stateless access operations. Accordingly, different versions of these monolithic programs had to be programmed for desktop and web use.

The sequence of different applications within a taskflow, if a taskflow was implemented, also consisted merely in a static chain of prescribed applications which had been stipulated in advance and could not be modified by the circumstances of the specific use.

Finally, it is currently likewise possible only to a very restricted degree or even impossible to interrupt a taskflow, for example a clinical taskflow, during handling, to continue it at another location, and possibly, moreover, to conclude it at the original location because it has not been possible to adapt the applications to the changing environments.

Previous approaches to a solution involved a separation between the different variants of applications, for example between desktop and web applications. It was therefore necessary to develop and maintain two different application architectures and source code routes if an application was both in desktop and in web use or was provided on computers with very different hardware configurations or with/without network access. Business processes for medical imaging which comprised such individual applications did not usually exist on account of the limitations.

### SUMMARY

In at least one embodiment, the present invention demonstrates a way which allows the development process for applications in the medical field to be simplified and, in particular, speeded up and which increases the flexibility for creating the applications, and which permits flexible adaptation of taskflow applications, including dynamically over time, to the use environments, particularly deployments, without reprogramming.

At least one embodiment of the present invention is directed to a method. Advantages, features and alternative embodiments mentioned in this context can likewise be applied to other methods, to a system or to a product. Accordingly, embodiments of these methods, systems or products can likewise be developed by way of the features which have been described or claimed in connection with one of the methods, and vice versa.

In at least one embodiment, a method is disclosed for creating a modular application, comprising:

a set of modules is provided in which at least one functionality for creating the application is respectively implemented,

functionalities required for the respective application are selected, and

the selected functionalities are configured for an application,

where the modules are already in the form of compiled executable program code and at least particular modules are designed for different use environments, and where modules are automatically selected and the application is configured such that modules suited to different identified use environments can be dynamically connected together at runtime without the need to recompile the application.

A use environment is to be understood to mean all those aspects outside of an application which influence the runtime behavior of the application or its interaction with the hardware or other applications within the target computer or client. Examples of aspects of the use environment are the processing power of the target computer, the available memory space, whether this be hard disks, optical disks or main memory space, the existing graphics output capabilities and options, network integration, the site of the appliance and/or the use of the target computer. The processing power can have a decisive effect on the runtime behavior of the target computer when executing an application, as can the total available memory space.

Graphics output options, particularly in the case of graphics coprocessors, as are known, likewise influence the output capabilities of applications, whether it be in terms of resolution, colorfulness or the capability of three-dimensional presentation of data. The network integration, that is to say the speed, type and state of a connection between the target computer and the network, can likewise interfere with the execution of the application. The site of the target computer, for example within a prescribed environment of a clinic or mobile for use at home, likewise influences the execution of applications. Furthermore, the use environment may include a deployment strategy for the target computer.

Finally, the use of the computer is a metavariable which can nevertheless influence the application, for example because target computers used by several people encounter resource division, and variants of applications can take different purposes of use into account. In one embodiment, the term “target computer” is used as a synonym for the term “client”.

The inventive solution is based on an n-layered system architecture which includes different components which for their part are associated with different layers. By way of example, the separation between the software layers stipulates what portions of the application are to be executed on a server and what portions of the application are to be executed on a client. In line with at least one embodiment of the invention, it is possible to ensure dynamic interconnection of the modules, so that the application can be used both in a web deployment and in a desktop deployment without the need for any change and fresh compiling. The use environment therefore comprises an online mode or an offline mode and/or various deployments.

Preferably, in at least one embodiment, the application respectively includes modules in a front end (presentation layer) and in a back end (business logic), with at least one respective module from the front end being able to be interconnected to at least one module from the back end via data paths.

At least one embodiment of the invention's modular design, including a multiplicity of modules for creating the applications, advantageously makes it a simple and rapid matter to expand the set of modules and/or to replace it with others without the need for further changes. By way of example, it is thus possible to deliver a new version of an individual module without the need for the entire application to be recompiled.

The “modules” are applications, application components or other submodules which are in the form of executable program code and hence have already been translated. The content of these modules is in no way limited and may be based on a wide variety of functionalities, such as a viewing modality, a reporting modality, a volume module, a 3D module, a transfer module etc. The modules may preferably be separate from one another and functionally-independent. They can be combined with other modules in building block form. Furthermore, it is possible for a module to be present in respective different versions.

At least one embodiment of the invention automatically uses the version which is compatible with the other modules or layers to be used in order to create the application, in particular the layer above can select the respective suitable version of the module for a layer below. The selected modules are preferably connected together dynamically, so that configurable parameters can also be included in this. The modules can be called at runtime and/or integrated at compiling time by the application—usually by means of a call. In addition, it is possible for individual modules (e.g. from a specifically selected toolkit, comprising a set of business components) to be interchanged with one another, even in different versions and without the need for the entire toolkit to be retranslated (as is the case with the libraries known today). Preferably, the functionalities, modules and/or services or provided services are encapsulated.

In an example embodiment, the inventive solution is based on the .NET technology developed by Microsoft, taking account of the inventive concept, based on a component architecture. This makes it possible to generate medical applications very easily and quickly which can be used in different use environments (e.g. desktop use or web use) and in different versions. Advantageously, the application development engineer does not need to concern himself with the different versions of the respective modules. Furthermore, the modules guarantee that an application can be generated very quickly. This is an important advantage particularly within the context of what is known as rapid application development (RAD).

In a further step, the applications generated in line with the invention can be interconnected to form a taskflow and hence can be used for implementing various business processes within the context of medical image processing or can be used in business processes again without the need to retranslate the entire application. The modular concept allows an application to be automatically used again in the same or in other business processes without the need for it to be reprogrammed or adapted in another way.

In addition, an advantage can be seen in that the application development engineer only needs to deal with the modules which are relevant to the creation of his application. It is therefore possible to implement the application in a more resource-saving manner.

An example embodiment involves a 5-layered architecture, particularly a software architecture. In alternative embodiments, however, it is at all times possible to determine other structuring for the architecture. Starting with the 5-layered architecture's layer which is arranged at the top location in the hierarchy, the architecture comprises the following layers:
a presentation layer which is intended to present the data and is therefore a front end.
a business process layer which comprises various business process logic modules and can also be called a web layer;
a controller layer which is intended to provide business forms,
a business logic layer which is used to provide various business components, and
a service layer which is intended to provide data, transfer and/or infrastructure services in the form of local and remote service components.

The concept of n-layered applications or n-tier applications is known in the prior art and it's principal has already been presented rudimentarily above with the aid of the three-layer presentation control and model of the activities for syngo.NET®. The basic idea of separation of the individual function levels is otherwise known, by way of example, from network protocols such as TCP/IP or the ISO layer model. In one variant of an embodiment of the invention, provision is made for the identified use environment to be used to stipulate what layers of the model are installed on the target computer and what layers remain outside of the computer and are accessible via a network, for example. An application layer is therefore to be understood to mean a feature of the application with logically grouped functionality which can be regarded as a block for the inventive method and, regardless of other embodiments of the invention, is loaded as such into the main memory.

The component architecture and the interconnection of the different modules in the medical domain allow application creation which is optimized in terms of efficiency. All modules, particularly the business and service components, are version-controllable. Within the context of an embodiment of the invention, “version-controllable” is intended to mean that modules or components of an application or of different applications can be used, interconnected to form an application and/or applied in respective different versions beside one another, or in parallel.

In line with an embodiment of the invention, the method accesses a (taskflow) manager instance which is provided as a separate executable file and is intended to handle taskflow instances which are executed within an application container or within a container. The manager allows maintenance, termination, resumption even on remote machines (remote), activation and deactivation of a user interface, termination (stop) and completion of taskflow instances. If provision is made for a taskflow to be started which is not available on the respective machine, this taskflow is installed on the respective client machine by what is known as “zero-admin-deployment”. The term “zero-admin-deployment” is characterized by the functionality that any management effort for deployment of the module is avoided. Any management effort is therefore completely decoupled from the respective application.

In line with an embodiment of the invention, the following deployment scenarios for the taskflow activities can be covered:
thin client,
rich thin client,
rich client,
adaptive client,
fat client, and
web service.

The manager comprises a user interface which is intended for tabular display of the following parameters:
taskflow-ID, which uniquely identifies the respective taskflow,
the status of the taskflow. This identifies whether or not the taskflow has already been initialized;
the data of the taskflow generation;
the current activity which is now in progress,
the current task which is now being executed, and
the name of the machine.

In another advantageous embodiment, the inventive method accesses what is known as a version mechanism, which is intended to automatically select from the set of fundamentally available modules the respective relevant module which is best suited to the respective application in the respective use environment. In particular, the optimized version of the respective module is determined here. This allows a further degree of flexibility to be achieved. In addition, the potential for error can be reduced, this previously having arisen through the use of incorrect or incompatible versions of modules.

At least one embodiment of the inventive solution is based on a specific architecture model which is described in more detail further below both in logical and in physical respects. Besides the aforementioned five layers, it includes a plurality of components which are respectively associated with a layer and can be interconnected in diverse ways. In this context, individual components and modules can be isolated and can be interconnected independently of one another in different applications. The interconnection of the individual components on the various layers is preferably performed by the manager.

In an example embodiment of the invention, the method is oriented to creating an application. In one development, the method (and accordingly also the system) is equally also designed for operating and/or maintaining an application. Furthermore, the inventive method can be used to create not only the applications themselves but also separate components of an application. A generic development frame is provided for this purpose.

It should be pointed out that the sequence of the steps in the method does not have to be observed imperatively, and alternatives also provide another order for the method steps, or for individual steps to be brought forward in time.

Another way of achieving the object of an embodiment of the invention involves a product which, in particular, may be in the form of a computer program product and comprises hardware modules and/or software modules and is intended to provide an infrastructure for the communication by a large number of applications. The product is designed using the features of the method of at least one embodiment. In this context, it should be noted that part of the product may be designed on a client and another remaining part may be designed on the server. In other embodiments, the product may equally be depicted as a distributed product on another architecture.

In another aspect, an embodiment of the invention is directed toward a method for executing at least one modular application, on the basis of a use environment for a target computer, the method comprising:
a use environment existing on the target computer is established; and
modules of the application are loaded into the target computer and are dynamically connected together on the basis of the identified use environment using a previously stipulated configuration for the application, and are executed.

Within the context of embodiments of the present invention, a target computer is to be understood to mean a computer or a similar data processing installation which is intended to execute a taskflow and whose memory, for example whose main memory, can have the applications or features of these applications which are necessary to execute the taskflow loaded into it, said applications or parts of applications subsequently being able to be executed by a central processing unit in the target computer.

Within the context of embodiments of the present invention, “establishment” of the use environment is intended to be understood to mean that either information data which are on the target computer (e.g. regarding the deployment strategy) or direct interrogation of the hardware and its states or a combination of these options is/are used to create an overview of the use environment which allows the system to stipulate how the applications need to be configured.

By way of example, the use environment may have been defined by a data structure which is on the target computer and which can be read and evaluated. The data structure may preferably be an XML-based data structure. It is also possible to perform tests or benchmarks on the target computer in order to be able to identify aspects of the use environment, which can be done as an alternative or in addition to the data structure. When establishing the use environment, it is also possible to resort to functions of the operating system or of a runtime environment in order to determine the use environment. By way of example, the use environment can be established by a first application which can be executed either autonomously or in an application container etc. in which it is embedded on an appropriate computer. In functional terms, it implies the capability of being able to identify or determine the use environment through suitable functions.

In line with at least one embodiment of the invention, the applications configured in this manner then have their modules loaded into the target computer and executed. In this context, modules of applications are to be understood to mean all kinds of components of applications which are known in the prior art and which collectively result in executable grouped functionalities within an application. As an example of modules, reference will briefly be made to the functionality of the syngo.NET® environment developed by Siemens for presenting and evaluating medical data. In the case of syngo.NET® the individual applications of a taskflow are in the form of what are known as application containers. This comprises the actual activity which the functionality of the application implements for the medical data, and also a series of further parts which provide an execution environment for the activity and are used for integration into an operating system.

By way of example, this includes the provision of a menu which can be used to control the activity, of a status bar for displaying the status of the activity, a group of generic views for presenting data, a controller for the container, model components for processing and accessing data etc. Activities in turn comprise the three features (tasks or components) View, Controller and Model, with View containing functionalities for display and interaction with the user, Model adopting the mechanisms for processing and accessing data, and the controller undertaking control of the execution within the activity and also of the interaction between View and Model. Each of these tasks in turn comprises a number of task steps which need to be executed in succession and which for their part in turn comprise a number of components. An activity or a task step interacts with the environment, that is to say with the container, but also with preceding and subsequent applications, activities or task steps using what are known as ports, which are implemented by the controller on the respective level.

In this context, all the conceptualities used above for identifying parts of the presented application in syngo.NET are to be understood as features of the applications within the meaning of embodiments of the invention.

Preferably, a plurality of applications form a taskflow, i.e. a sequence of cooperating applications with data and status transfer.

In one example embodiment, the method includes:
the use environment is periodically established in order to identify changes or planned changes in the use environment, and
following identification of a change or planned change, modules of the applications which are suited to the changed use environment are reloaded and/or replaced as required.

In this case, the periodic establishment of the use environment helps to identify changes in the use environment in order to be able to modify the applications dynamically, that is to say at actual runtime for the application or the taskflow comprising applications, such that they adapt themselves to the changed conditions in optimum fashion. An example of a changed use environment is when further users log onto a multi-user system (altered resource distribution) but a network connection is also broken, so that network services are no longer available and need to be emulated by reloading suitable modules of applications, with reloading of the application modules also possibly involving executing them such that the data required for handling can be made available locally without a network connection, for example even before the network connection is broken, provided that the break which is to be expected is identified in good time, e.g. as a result of the user logging off.

At least one embodiment of the inventive method can be carried out by automatically linking to central or remote service infrastructures for supporting an online and offline mode, with data and/or services being able to be provided locally and/or via a network.

Preferably, the applications are what are known as n-layered applications, with information being used to establish a use environment and to load appropriately suited layers of the application into the main memory for execution and possibly to set up connections via a network to required services which provide the loaded layers with the functionality of the nonloaded layers.

Within the context of at least one embodiment of the present invention, a deployment strategy is to be understood to mean a strategic decision regarding to what use environment what features of the layer structure are supposed to belong locally and what elements are supposed to belong remotely. Accordingly, a deployment can be characterized by the currently available use environment, that is to say, by way of example, one deployment for web use, one deployment for desktop use etc.

Loading of layers into the main memory of a target computer is to be understood to mean that operating system functionalities are used to provide a memory space in the main memory, to read the individual features of a layer which is to be loaded or the layer as such from a mass memory and to transfer the binary data from the layer (executable code) to the main memory. Execution is to be understood to mean that the central processing unit in the target computer executes the application layers' program code which is in the main memory in the usual way. A nonloaded layer is accordingly to be understood to mean one which is not resident in the target computer's main memory.

Preferably, the n-layered applications have at least one presentation layer for presenting information and for user interactions, a business process layer which includes various business process logic modules, a controller layer which is intended to provide business forms, a business logic layer which is used to provide various business components, and a service layer which is intended to provide data, transfer and/or infrastructure services in the form of local and remote service components.

The service layer may contain a stateful access layer for accessing or for providing data and services locally or via a network, and a stateless access layer for accessing or for providing data and/or services locally and/or via a network.

This five-layered structure essentially corresponds to the model already presented above, expanded by service layers for providing data and services. An important core for this aspect of the invention is the embodiment with two service layers, a top one of which is stateful and a bottom one of which is stateless. The stateful access layer provides all the necessary functions for the layers above, so that these do not normally have to access the stateless layer at the bottom and therefore do not have to take account of its state. Rather, only the stateful service layer is responsible for implementing all access to data and services. The impact achieved by this is that the layers above do not, in principle, have to be adapted to the layers below in terms of “local” or “remote” availability but rather can remain unchanged after they have been programmed, regardless of the use environment. This concept can also be extended to higher layers.

In example embodiments of the invention, the deployment strategy may be a fat client, a rich client, a rich thin client, a thin client and/or a web service. In the case of the fat client, all layers of the n-layered application are executed on the target computer. This is therefore the case of an independent or standalone application which has no kind of network connection and for which all services and data therefore need to be made available locally. In the case of the rich client, only the stateless access layer is executed on a remote computer (application server), while the other layers remain on the target computer and are executed there. The stateful access layer deals with the interaction with the stateless access layer via the network and with the interaction of the business layer above or the layers which are further above.

In the case of the rich thin client, the presentation layer and optionally the business process layer are executed on the target computer, while the controller layer, the business logic layer and the service layers are executed on a remote computer. This deployment strategy is suitable for less powerful computers or for computers which are connected to high-power computers via a rapid network connection such that no bottlenecks are to be expected for the network transfer or the execution of data on a remote computer. Accordingly, the rich thin client can be kept simpler in terms of the performance of the target computer implementing it than in the case of the fat client or the rich client.

In the case of the thin client, only the presentation layer is executed on the target computer, while the business process layer, the business logic layer and a local, stateful service layer are executed on an application server, and the remote, stateless service layer is executed on a remote service computer. With this deployment strategy, three different computers are involved in executing the application and need to interact with one another in coordinated fashion.

Finally, in the case of the job service, an HTML-based program is executed on the target computer, the controller layer also being able to be executed within the web browser, and other services required for calling the applications are executed on an application server and communicate with the layers which are on the target computer via the HTTP protocol customary on the web or a comparably suitable protocol. Preferably, at least some of the software objects forming the layers are programmed independently of the deployment strategy, so that these need to be developed only once for all the different deployment strategies.

Preferably, the presentation layer, the business process layer, the controller layer and the business logic layer are programmed independently of the deployment strategy. The service layer's stateful access layer may be designed to implement interactions with the layers above it such that the deployment strategy is irrelevant to the layers above it, that is to say that the stateful access layer renders the stateless access layer transparent to the layers above so as to reduce its programming variants on the basis of the deployment strategy.

In one example embodiment of the invention, the use environment may also include the performance of the target computer (e.g. processing power, memory space etc.), with modules of the applications which suit the performance of the target computer in terms of the algorithms used, the complexity of the display of user interface elements and/or the volume of data made available being able to be reloaded, that is to say being able to be loaded subsequently. In this preferred embodiment, action is taken in individual modules of the respectively used applications, and these are assembled in modular fashion, so that the final effect is that the runtime environment is the first thing for which a stipulation is made regarding what modules of applications are present and how the whole applications interact with one another.

The use environment may also comprise the number of available screens on the target computer, with modules of applications which are intended specifically for displaying user interface elements on the existing number of screens being able to be reloaded. This allows the respective displaying application to be flexibly adapted to the situation of the screens on the target computer. Particularly in the medical domain, the circumstances frequently arise that a computer has more than one screen on it, for example in order to be able to edit image data on one workstation and simultaneously present them to colleagues in order to allow a discussion process regarding treatment strategies etc.

It is also conceivable for there to be more than one monitor on a target computer in order to allow the image data to be simultaneously presented to the patient and explained by the doctor. In this case, however, the display of data from menu items, buttons etc. also needs to be adapted to the screen. Thus, by way of example, screens for patients require no kind of image elements which permit interaction, since presentation is all that is required, whereas the workstation screen itself needs to have the necessary manipulation elements on it. Even when a plurality of screens are used as workstation screens, it may be desirable for these to be in different forms in order, all told, to provide a split user interface for using the program and controlling it.

In another example embodiment, the taskflow is generated from consecutively connected applications which are available in different application variants, with the use environment being used to determine what application variants are consecutively connected in the taskflow. At least one example embodiment of the invention is therefore not limited just to the configuration of features of the individual applications but rather also allows flexible composition of the taskflow from applications which are on hand in different variants in order to be able to adapt the overall taskflow likewise to the existing use environment.

Preferably, the taskflow in at least one embodiment of the present invention basically comprises a plurality of, that is to say at least two, consecutively connected n-layered instantiated application containers. In this case, an application container is to be understood to mean a construct which, besides the actual semantic part for providing a functionality, also contains parts which provide general functions which need to be on hand in all application containers, as already described above for the introduction to syngo.NET®.

The use environment is preferably established in the first instantiated application container in the taskflow in order to allow the use environment to be identified when the taskflow is actually started and the first features are loaded, so that it is possible to stipulate the necessary, established features early.

The method can access a taskflow manager instance which is provided as a separate executable file and is intended to handle taskflow instances which are executed within an instantiated application container.

Preferably, a business process layer accesses a central strategy component, in particular in order to manage individual components and/or instances.

In another example embodiment, the use environment is defined by a data structure which is on the target computer. Thus, beforehand and without complex test routines, it is actually possible to stipulate the appearance of the use environment for a particular target computer and also what deployment strategy etc., is intended to be put to use.

In another embodiment, the invention is directed toward a taskflow architecture system. With regard to the system, everything which has already been said above with regard to the method applies, and vice versa, so that alternate reference is made. The inventive taskflow architecture system has:
at least one application which is composed from a plurality of modules, and
a configuration object which is intended to load modules of the at least one application on the basis of an established use environment.

The terms used here correspond to the definitions already given above for the method.

Furthermore, a configuration object is a programming object, such as a program module, a program object etc., which is capable of interacting with the system such that it gains knowledge of what features of the application need to be loaded for the identified use environment and which, either itself or using the operating system, loads these features into the target computer's main memory and connects them together via the existing infrastructure in order to generate executable applications comprising features. This can be done by creating a list or other data structure with application features which are to be loaded.

The use environment can be established periodically in order to identify changes or a planned change in the use environment; also, the configuration object may, following identification of a change or planned change, be intended to reload and/or replace features of the applications which are suited to the changed use environment as needed.

As mentioned above, the use environment preferably comprises a deployment strategy, the processing power of the target computer, the available memory space, the existing graphics output options, the network integration, the site of the target computer and/or the use of the target computer.

The applications used in the inventive system of at least one embodiment may be n-layered applications, with the use environment being able to be used to establish a deployment strategy which is preferred for the target computer, and the configuration object loading appropriately suited layers of the applications into the main memory for execution and possibly setting up connections via a network to required services which provide the loaded layers with the functionality of the nonloaded layers.

The n-layered applications may be designed as defined above.

In addition, the taskflow architecture system based on at least one embodiment of the present invention may comprise a deployment strategy which has been indicated above.

Preferably, the use environment notionally comprises the performance of the target computer, with features of the applications from the taskflow which suit the performance of the target computer in terms of use in the algorithms, the complexity of the display of user interface elements and/or the volume of data made available being able to be reloaded.

In addition, the use environment may comprise the number of available screens on the target computer, with modules of applications which are intended specifically for displaying user interface elements on the existing number of screens being able to be reloaded.

The possible taskflow may comprise consecutively connected applications which are available in different application variants, so that the use environment can also be used to identify what application variants are to be consecutively connected in the taskflow.

The taskflow may preferably comprise a plurality of consecutively connected n-layered application containers.

In this case, the configuration object may be a feature of the first application container in the taskflow. The use environment may have been defined by a data structure which is on the target computer.

Other advantageous refinements, aspects and details can be found in the dependent claims, in the description and in the appended drawings.

### BRIEF DESCRIPTION OF THE DRAWINGS

The following detailed description of the figures discusses example embodiments (which are not to be understood as restrictive) with their features and other advantages with reference to the drawing, in which:

FIG. 1 shows an example of the design of an n-layered module structure based on an advantageous embodiment of the present invention,

FIG. 2 shows a basic design of an application container from syngo.NET® to explain a software architecture on which an embodiment of the invention is based, and

FIG. 3 shows different deployment strategies based on an embodiment of the invention.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the terms “and/or” and “at least one of” include any and all combinations of one or more of the associated listed items.

The general aim of an embodiment of the invention is for the development of a modular architecture, which, by way of example, is based on Microsoft's .NET technology, and a flexible application architecture which can be downloaded on a target computer, for example using a URL, to solve the problems described at the outset. In this context, the flexible application architecture which can be downloaded according to need and the use environment plays a central roll because it identifies the current use of the application and loads and arranges the modules of the application, for example their layers or other kinds of features, accordingly, such that the application's current use environment remains “concealed” from the application and does not need to be taken into account for the programming or for the start of a program.

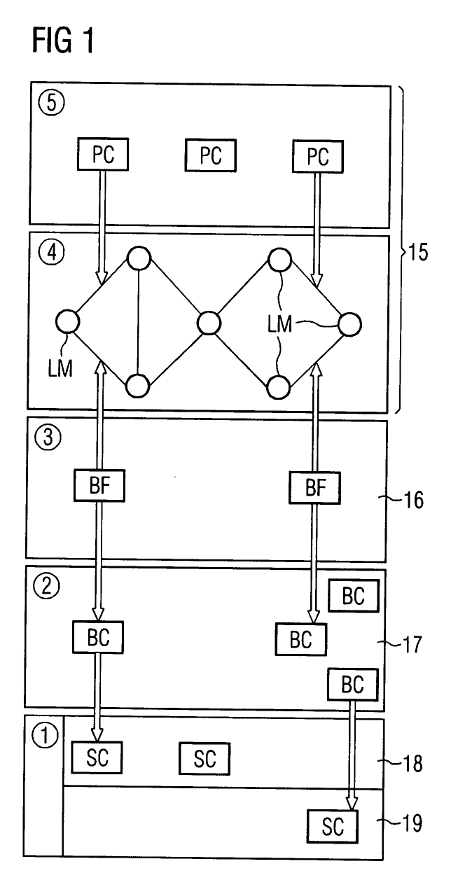

FIG. 1 shows the logical architecture model, which comprises, as the bottom layer, a service layer (e.g. local) and/or a data access layer (e.g. remote), so that automatic connection to central and/or to local or remote service infrastructures can be provided for the applications generated in line with the invention. This bottom layer therefore comprises a multiplicity of usually different service components SC as modules. This layer therefore comprises access to local service components SC and to remote service components SC (such as SOA web services). All told, the service layer 18, 19 comprises infrastructure services (such as communication services, logging services etc.), data and transfer services (such as transfer and print services) and processing services (such as volume services, graphics services etc.).

As the second-from-bottom layer, this is followed by the business logic layer which is intended to provide different “toolkits” in the form of a set of business components BC. This layer incorporates a component architecture. It comprises various business components BC. In this context, there are application-specific and generally usable business components BC, the first being able to be connected together only for one respective application, while the latter can be used for a plurality of applications. For these modules, by way of example, a segmentation module, a positioning module, a circulation module, a result table module (e.g. for a cardiac examination) and a volume module, a display module, a report module, an editing module, a document module, an examination module etc. May be sited as cross-application modules.

The third layer to be mentioned is a controller layer which is intended to provide business forms BF and/or business pages. It is also referred to as a service bus and can be considered to be a back end within the context of application development. In this case, by way of example, an identification step may be followed by a segmentation step and a quantification step. On this level too, it is possible to differentiate between application-specific modules and general-use modules.

The second-from-top layer to be mentioned is what is known as a business process layer, which comprises various business process logic modules LM. This incorporates a business architecture. This layer accommodates the following: a taskflow, activities and a central strategy component, and also tasks and/or jobs which can be interconnected in line with an embodiment of the invention.

The adjoining top layer is a presentation layer for clinical tasks which is intended to present the data and can also be referred to as a front end within the context of application development. In one embodiment, it may also relate to what is known as a client layer. This comprises a plurality of presentation components PC, e.g. also as tasks in a taskflow.

An example design for the n-layered system or architecture model with different subsystems will be presented briefly below:
layer 5:
presentation logic and services for adaptive client user interfaces as the top layer,
a specific set or selection of presentation forms and presentation components,
layer 4:
business process logic and taskflow instrumentalization,
a specific set or a specific quantity of what are known as taskflows,
layer 3:
a specific set of tasks and jobs of a central strategy component, and a service bus,
layer 2:
business logic,
a specific set of business tasks which are available as tools and application back ends, and
a specific set of business components for implementing domain toolkits,
layer 1:
service and data access logic,
a specific set of local service components for implementing a domain framework, and
a specific set of remote service components (e.g. SOA web services) for interacting with PACS and/or RIS systems and/or other information systems (e.g. with SOARIAN).

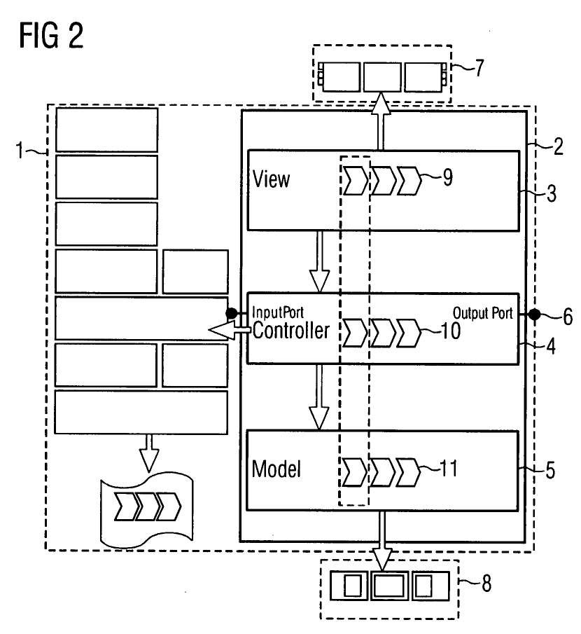

FIG. 2 shows a generic application container containing an entered activity. The generic container provides a runtime environment for applications or activities. In this case, the container 1 contains an activity 2 which follows the Model-View-Controller design pattern and therefore has a view layer 3, a controller layer 4 and a model layer 5. The view layer 3 is represented by a generic frontend component which is responsible for the user interface, and the model layer 5 is represented by a generic back end which is responsible for the business logic, the two being connected to one another by the controller layer 4, which is responsible for user interface action handling. The controller layer is also responsible for activating generic command channels between frontend and backend components.

In addition, the backend layer or the backend part 5 of an activity has input and output ports 6 which are required for the flow of data between automatically connected activities which are executed within a taskflow. FIG. 2 also shows what is known as a presentation form 7, which provides functionalities for display by the view 3, and also business forms 8, which provide the model 5 with functionalities. Each of the layers 3, 4, and 5 in turn comprises individual task steps 9, 10, 11 which, consecutively connected, implement the actual functionality of the respective layer and which in turn may be composed from a series of components (not shown). This flexible, modular design allows each application to be assembled on an ad-hoc basis and interconnected ready for operation in the manner of a “construction set system” from the modules which are respectively best suited to the purpose of use or the use environment, whether these be activities, their layers, task steps or components.

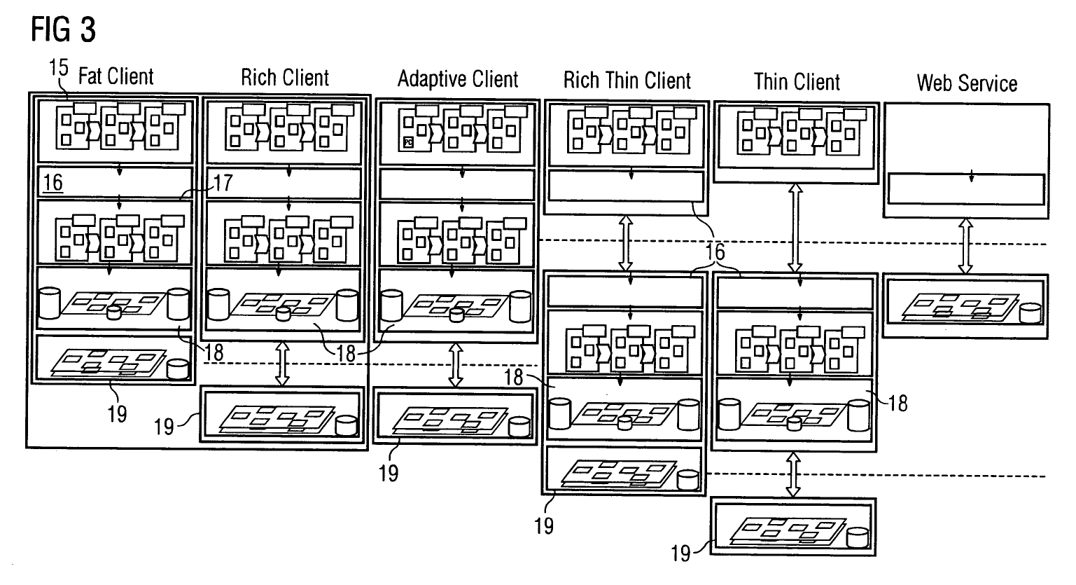

FIG. 3 shows various preferred forms of deployment strategies which can be implemented with the present invention. As demonstrated by FIG. 3, it is possible to deploy components which are designed to be compatible with syngo.NET and which are very flexible and range from a single, executable file to a plurality of executable files and even go beyond machines or network boundaries. This figure shows the following: a combined presentation and business process layer 15, a controller layer 16, a business logic layer 17 and also a local service layer level 18 and a remote service layer level 19. On the left-hand side, FIG. 3 shows a fat client and a rich client with features or layers based on FIG. 1, with the rich client optionally also having remote services available which it can access and which therefore do not need to be on hand on the local computer.

These two deployment strategies can be used simultaneously to allow a computer to be used either locally or in a network, which is useful in the case of laptops, for example, which are sometimes connected to a network and hence have access to all data and services but which sometimes also need to operate in standalone mode, so that not only do the necessary services need to be implemented locally but also at least the data from the current taskflow execution need to be on hand locally, for example image data for a particular patient. In the case of a fat client, “zero administration” is of no importance and is often not actually wanted. In the case of rich clients, a firewall may also have been connected upstream prior to access to a network.

Another deployment strategy is an adaptive client, in which, in similar fashion to in the case of the rich client, the stateless or remote service layer 19 is implemented on a remote computer, while the other layers of the n-layered application architecture are executed on the target computer. In contrast to the rich client, however, an adaptive client cannot change over to the fat client mode, since this deployment strategy is not provided for it.

In the case of the rich thin client, another deployment strategy based on the invention, one special feature is that the controller layer 16 is bipartite or is designed as a network functionality in which one part runs on the target computer and a second part, interacting and communicating with the first part, runs on a server or similar in a network. This reduces the demands on the target computer's hardware, since many operations involving a high level of processing can now be executed on a high-power computer which can be shared by several users, and only the presentation of the data is calculated on the target computer.

A thin client, such as an HTML-based thin client, no longer contains any control layer 16 on the target computer. Rather, most of the functionality, apart from the pure user interface and the data presentation, is implemented on an application server; only an HTML-based interface runs on the target computer. The stateless service layer 19 is also on one or more further network computers which are accessed from the application server.

Finally, a web service can be regarded as the simplest possible implementation of an n-layered application for the target computer, since this now runs only an ordinary web browser with a user interface, which allow access to the applications running on one or more remote computers. Hence, any computer on which a web browser is running is available as a target computer.

As FIG. 3 demonstrates, it is possible to deploy components implemented in line with an embodiment of the invention very flexibly, from a single “executable” to multiple “executables” and even beyond computer or network boundaries. For imaging systems, for example in the area of medical engineering, power reasons may mean that it is advantageous in respect of user interactivity, the use of target computer resources, the need or expendability of network connections, scalability, multiple users etc., to focus on adaptive clients, rather than on thin clients or web clients, for which the status (state) is often more difficult to manage than in the case of adaptive clients.

It goes without saying that embodiments of the invention allows other deployment strategies and also variants of the deployment strategies presented by way of example, and these are intended to be covered by the scope of protection of the invention.

It is also possible to combine the various elemental aspects of embodiments of the invention with one another, for example the simultaneous stipulation of a particular deployment strategy for a target computer and the selection of features of the presentation layer, in order to use one or more monitors for displaying user elements.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for creating a modular application, the method comprising:
providing a set of modules in which at least one functionality for creating the application is respectively implemented;
selecting functionalities required for the respective application; and
configuring the selected functionalities for an application, wherein the modules are in a form of compiled executable program code and at least particular modules are designed for different use environments, and wherein modules are automatically selected and the application is configured such that modules suited to different identified use environments are dynamically connectable together at runtime without a need to recompile the application.

2. The method as claimed in claim 1, wherein the application is designed using an n-layer system architecture, wherein modules belong to different layers and modules suited to different identified use environments are associated only with those layers which are relevant to interaction with the respectively identified use environments.

3. The method as claimed in claim 1, wherein the use environment at least one of is an online mode, is an offline mode and comprises various deployments.

4. The method as claimed in claim 1, wherein the application respectively comprises modules in a front end and in a back end, with at least one respective module from the front end being able to be interconnected to at least one module from a back end via data paths.

5. The method as claimed in claim 2, wherein the system architecture is 5-layered and comprises the following layers, starting with a top layer in the hierarchy:
a presentation layer intended to present the data,
a business process layer including various business process logic modules,
a controller layer intended to provide business forms,
a business logic layer used to provide various business components, and
a service layer intended to provide at least one of data, transfer and infrastructure services in the form of local and remote service components.

6. The method as claimed in claim 5, wherein at least one of the business components and the service components are version-controllable.

7. The method as claimed in claim 1, wherein a plurality of applications are interconnectable to form a taskflow.

8. A method for executing at least one modular application, the method comprising:
establishing a use environment existing on a target computer; and
loading modules of the at least one modular application into the target computer, dynamically connecting the modules together on the basis of the established use environment using a previously stipulated configuration for the application, and executing the at least one modular application.

9. The method as claimed in claim 8, wherein a plurality of applications form a taskflow.

10. The method as claimed in claim 8, further comprising:
periodically establishing the use environment to identify at least one of changes and planned changes in the use environment, and
following identification of at least one of a change and a planned change, modules of the applications which are suited to the changed use environment are at least one of reloaded and replaced as required.

11. The method as claimed in one of claim 8, wherein the use environment comprises at least one of a deployment strategy for the target computer, the processing power of the target computer, the available memory space, the existing graphics output options, the network integration, the site of the target computer and the use of the target computer.

12. The method as claimed in claim 8, wherein the method is carried out by automatically linking to at least one of central and remote service infrastructures for supporting an online and offline mode, with at least one of data and services being able to be provided at least one of locally and via a network.

13. The method as claimed in claim 8, wherein the applications are n-layered applications and wherein a deployment strategy for the target computer is established and appropriately suited layers or modules of the application associated with layers are loaded into the main memory for execution and connections are set up via a network to required services which provide the loaded layers with the functionality of the nonloaded layers.

14. The method as claimed in claim 13, wherein the system architecture is 5-layered and comprises the following layers, starting with a top layer in the hierarchy:
a presentation layer intended to present the data,
a business process layer which comprises various business process logic modules,
a controller layer intended to provide business forms,
a business logic layer used to provide various business components, and
a service layer intended to at least one of provide data, transfer and infrastructure services in the form of local and remote service components.

15. The method as claimed in claim 13, wherein the deployment strategy comprises at least one of a fat client, a rich client, a rich thin client, a thin client and a web service, where
the fat client involves all layers being executed on the client,
the rich client involves just a remote, stateless access layer being executed on a remote computer,
the rich thin client involves the presentation layer and optionally the business process layer being executed on the client, while the Controller layer, the business logic layer and the service layers are executed on a remote computer,
the thin client involves the presentation layer being executed on the client, the business process layer, the business logic layer and a local, stateful service layer being executed on an application server, and the remote, stateless service layer being executed on a remote service computer, and
the web service involves an HTML-based program being executed on the client and all services required for executing the applications being executed on a remote computer.

16. The method as claimed in claim 13, wherein at least some of the software objects forming the layers are programmed independently of the deployment strategy.

17. The method as claimed in claim 14, wherein the presentation and business process layers, the controller layer and the business logic layer are programmed independently of the deployment strategy.

18. The method as claimed in claim 15, wherein the stateful service layer is designed to implement interactions with the layers above it such that the deployment strategy is irrelevant to the layers above it.

19. The method as claimed in claim 8, wherein the use environment comprises the performance of the client and it is possible to reload modules of the at least one application which suit the performance of the client at least in terms of at least one of the algorithms used, the complexity of the display of user interface elements and the volume of data made available.

20. The method as claimed in claim 8, wherein the use environment comprises the number of available screens on the client and wherein modules of the at least one application which are intended specifically for displaying user interface elements on the existing number of screens can be reloaded.

21. The method as claimed in claim 8, wherein a taskflow is generated from consecutively connected applications which are available in different application variants, and wherein the use environment is used to determine what application variants are consecutively connected in the taskflow.

22. The method as claimed in claim 8, wherein a taskflow for applications comprises a plurality of consecutively connected n-layered instantiated application containers.

23. The method as claimed in claim 22, wherein the use environment is established by a first instantiated application container in the taskflow.

24. The method as claimed in claim 22, wherein the method accesses a taskflow manager instance which is provided as a separate executable file and is intended to handle taskflow instances which are executed within an instantiated application container.

25. The method as claimed in claim 14, wherein a business process layer accesses a central strategy component.

26. The method as claimed in claim 8, wherein the use environment is defined by a data structure which is on the client.

27. A software architecture system, comprising:
at least one application, composed from a plurality of modules; and
a configuration object, intended to load modules of the at least one application on the basis of an established use environment.

28. The software architecture system of claim 27, useable to implement:
providing a set of modules in which at least one functionality for creating the application is respectively implemented;
selecting functionalities required for the respective application; and
configuring the selected functionalities for an application, wherein the modules are in a form of compiled executable program code and at least particular modules are designed for different use environments, and wherein modules are automatically selected and the application is configured such that modules suited to different identified use environments are dynamically connectable together at runtime without a need to recompile the application.

29. The method as claimed in claim 2, wherein the use environment at least one of is an online mode, is an offline mode and comprises various deployments.

30. The method as claimed in one of claim 10, wherein the use environment comprises at least one of a deployment strategy for the target computer, the processing power of the target computer, the available memory space, the existing graphics output options, the network integration, the site of the target computer and the use of the target computer.

31. The method as claimed in claim 25, wherein the business process layer accesses the central strategy component in order to manage at least one of individual components and instances.

32. A computer readable medium including program segments for, when executed on a computer device, causing the computer device to implement the method of claim 1.

33. A computer readable medium including program segments for, when executed on a computer device, causing the computer device to implement the method of claim 8.
